(19) United States
(12) Patent Application Publication
(10) Pub. No.: US 2023/0113331 A1
(43) Pub. Date: Apr. 13, 2023

(54) LOCALIZATION FRAMEWORK FOR DYNAMIC ENVIRONMENTS FOR AUTONOMOUS INDOOR SEMI-AUTONOMOUS DEVICES

(71) Applicant: Avidbots Corp, Kitchener (CA)

(72) Inventors: Marc GALLANT, Kitchener (CA); Teyvonia THOMAS, Kitchener (CA); Mark VANDERMEULEN, Kitchener (CA); Dan ERUSALIMCHIK, Kitchener (CA); Pablo Roberto MOLINA CABRERA, Waterloo (CA)

(21) Appl. No.: 17/964,873

(22) Filed: Oct. 12, 2022

Related U.S. Application Data
(60) Provisional application No. 63/254,549, filed on Oct. 12, 2021.

(51) Int. Cl. G05D 1/02; G01C 21/00

(52) U.S. Cl. CPC G05D 1/0274; G05D 1/024; G01C 21/383; G05D 2201/0203

(57) ABSTRACT

A hybrid mapping and localization system using continuous localization algorithms is disclosed. When a localization quality is sufficiently high, based on a validated points localization monitor metric, then the map updates are allowed to be made on the localization map. This helps localizing in dynamic environments because these environment changes are actually integrated into the underlying map, so that the particle filter does not snap to incorrect object locations.

### CROSS REFERENCE TO RELATED APPLICATIONS

The application claims priority to and the benefit of U.S. Provisional Patent Application Ser. No. 63/254549, entitled “LOCALIZATION FRAMEWORK FOR DYNAMIC ENVIRONMENTS FOR AUTONOMOUS INDOOR SEMI-AUTONOMOUS DEVICES” filed on Oct. 12, 2022, the disclosure of which is incorporated herein by reference in its entirety.

### BACKGROUND

The embodiments described herein relate to a semi-autonomous cleaning device, in particular to a system and method for a mapping and localization framework for a semi-autonomous cleaning device.

Robot localization is the process of determining, in real time at a relatively high frequency (˜20 Hz), where the robot is on a map representation of the environment. This map is known as the “original map” on top of which a number of mission-specific annotations such as cleaning regions, keep-out regions, etc. are made. The goal is to use a limited and affordable sensing and computing setup to make this localization determination, especially on cost-sensitive products such as Neo. With localization, the robot is then able to track paths planned on the same map geometry to complete the mission objectives, while obeying all navigational constraints.

Typically, the deployment staff, when deploying Neo for the first time in a brand-new environment, will need to map out the environment such that the annotations of mission goals and constraints can be added in the correct placements on the map.

### Adaptive Monte Carlo Localization (AMCL)

A frequently used algorithm in the open-source ROS (Robot Operating System) community, under the category of autonomous navigation software, is known as AMCL, or Adaptive Monte Carlo Localization, an odometry+lidar particle filter based localization algorithm on a pre-existing 2-D occupancy grid map.

AMCL uses a particle filter (PF), which uses “particles” (poses associated with probabilities of their likelihood to be the true pose of the robot) to represent arbitrary probability distributions of where the robot is likely to be, based on the starting pose, the history of control actions and sensor measurements, and their noise and correlation models. The control action propagates the particles, and the odometry and lidar measurements confirm the propagation based on how well the scans align with the underlying map.

AMCL is based on a static environment assumption, where changes of obstacle layouts are minor: the quantity of lidar hit locations is below say 30-50% (empirical estimate; for the sake of argument there is some threshold of change x % that can be handled) in any given observation frame. This does not hold true in many real-world environments to varying degrees and frequencies, including shopping centers, transportation hubs, warehouses, and retail stores. Large changes of greater than 30-50% can be occasionally to frequently observed, including new storefronts and construction (several times a year), long rows of luggage or baggage-handling carts (hourly to daily), shifting pallets inside racks (hourly to weekly), shifting racks or pallets in cross-docks (hourly to daily), or changes in material arrangements in stores (daily) and large seasonal displays (monthly), all constitute what is known as a dynamic environment.

Dynamic environments, therefore, are those in which the layout of the observed obstacles in the environment differ from what was observed during the initial deployment and is another name for non-static environments. These environments present a significant technical challenge to the indoor robotics community.

When the environment changes, the PF's particles cannot properly associate the lidar measurements of the new obstacle arrangements with the underlying map, thus leading to incorrect scan-map alignments resulting in the wrong pose estimate in the map. This results in both poor cleaning performance in that the robot can sway or drive off its intended cleaning paths without the robot knowing or able to do anything about it. It is also a safety concern, because sometimes the only safeguard against hazards such as cliffs or obstacles too difficult for all onboard sensors to see, is a map-based keep-out zone. Another safety concern is the potential for the robot's trajectory-tracking motion controller to induce overly large corrections to compensate for the perceived shift (i.e., error) in the robot's pose belief relative to the desired pose, leading to collisions.

Many localization algorithms exist in the literature, although the lifelong localization problem (which is another name for localizing in an ever-dynamic environment over long periods of time) remains unsolved to a degree, from the point of view of guaranteed localization accuracy especially over increasingly long-time horizons or extreme environmental change. Many developments/improvements have been made over the past decade to try to tackle the problem.

The core problem is how to precisely and continuously localize a robot in dynamic environments with a planar lidar array, IMU, wheel encoders, visual odometer, or other robot-centric means of localization sensing on the robot, using an existing 2-D occupancy grid map on the computationally constrained main robot computer. The accuracy should be within ˜5 cm for greater than ˜99% of operation, and no worse than 15 cm for the remainder (real world performance varies substantially and is hard to verify without a ground truth system on site).

The secondary problem, given the many approaches listed, is if there are many algorithms to try. It is difficult to adapt these algorithms to robots and semi-autonomous devices or to bring together common elements of each in existing and even new manners, to avoid redundancy, improve test modularity, and unit testing coverage.

There is a desire to explore continuous localization algorithms to address the problems.

### SUMMARY

A hybrid mapping and localization system using continuous localization algorithms is disclosed. When a localization quality is sufficiently high, based on a validated points localization monitor metric, then the map updates are allowed to be made on the localization map. This helps localizing in dynamic environments because these environment changes are integrated into the underlying map, so that the particle filter does not snap to incorrect object locations.

### BRIEF DESCRIPTION OF THE DRAWINGS

FIG. 1 is a perspective view of a semi-autonomous cleaning device.

FIG. 2 is a front view of a semi-autonomous cleaning device.

FIG. 3 is a back view of a semi-autonomous cleaning device.

FIG. 4 is a left-side view of a semi-autonomous cleaning device.

FIG. 5 is a right-side view of a semi-autonomous cleaning device.

FIG. 6 is a diagram illustrating an exemplary workflow of System1.

FIG. 7 is a diagram illustrating the SLAM workflow.

FIG. 8 is a diagram illustrating the alignment workflow.

FIG. 9 is a diagram illustrating an exemplary reference map.

### DETAILED DESCRIPTION

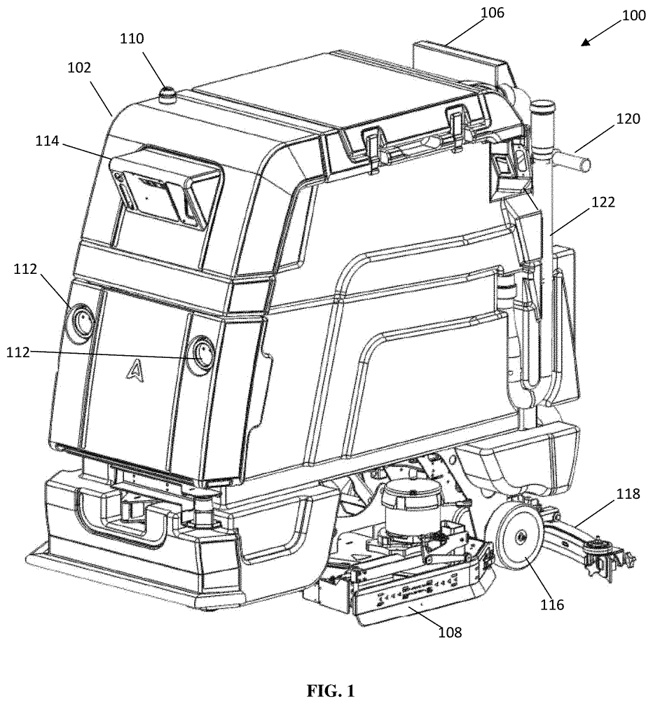

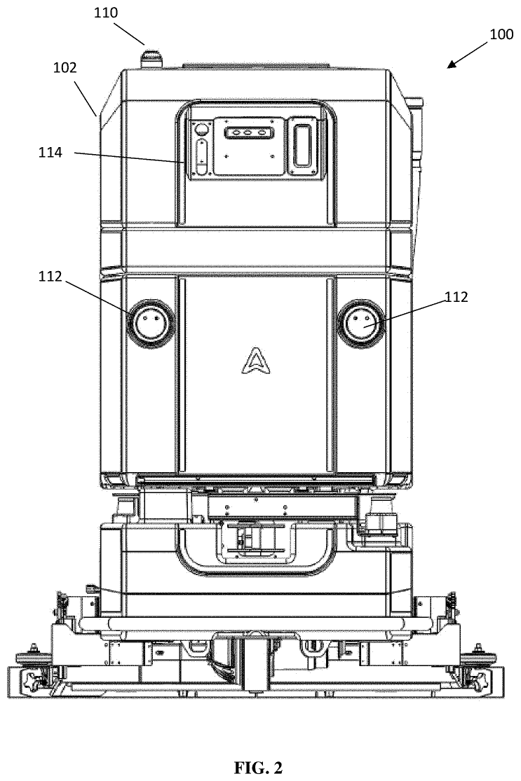

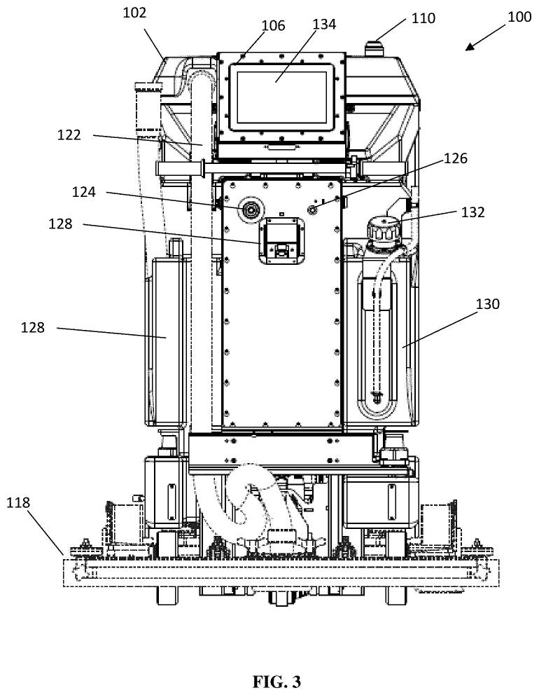

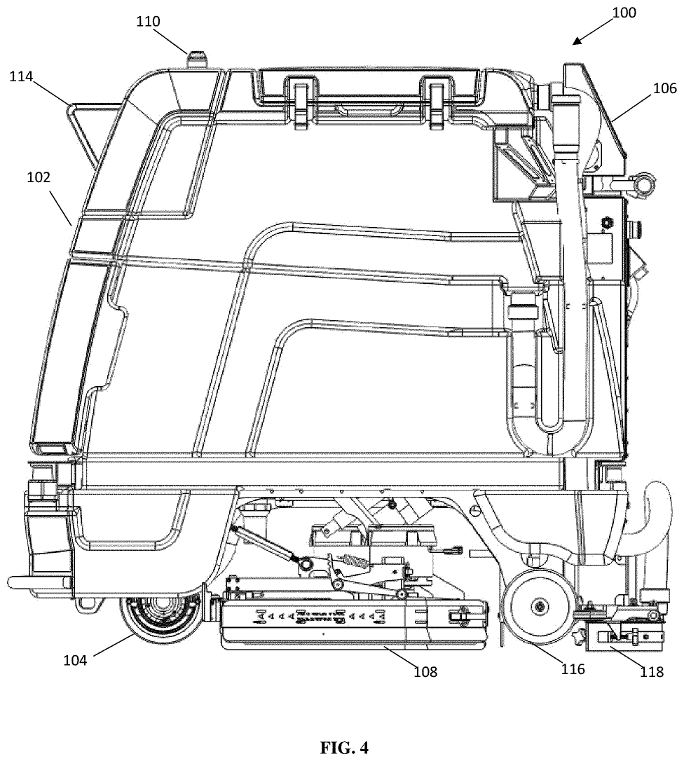

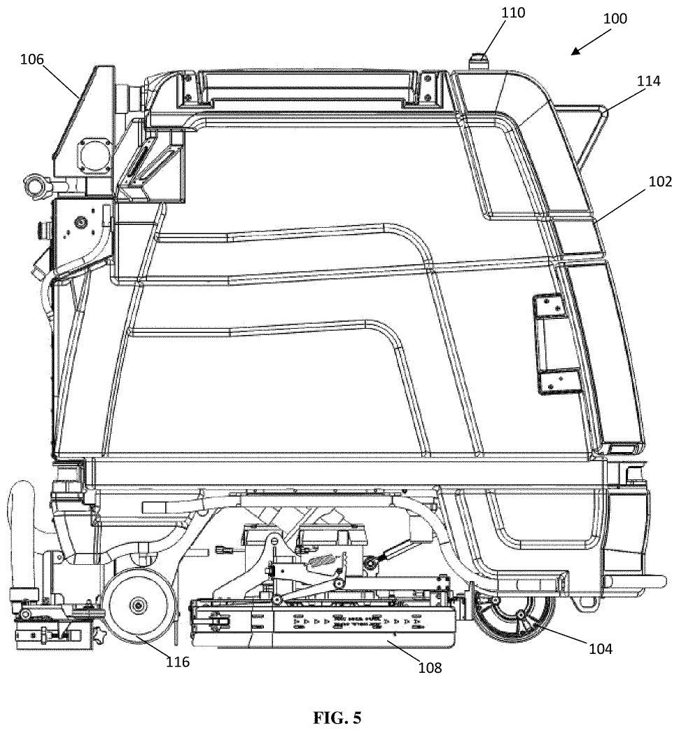

An exemplary embodiment of an autonomous or semi-autonomous cleaning device is shown in FIGS. 1-5. FIG. 1 is a perspective view of a semi-autonomous cleaning device. FIG. 2 is a front view of a semi-autonomous cleaning device. FIG. 3 is a back view of a semi-autonomous cleaning device. FIG. 4 is a left side view of a semi-autonomous cleaning device, and FIG. 5 is a right-side view of a semi-autonomous cleaning device.

FIGS. 1 to 5 illustrate a semi-autonomous cleaning device 100. The device 100 (also referred to herein as “cleaning robot” or “robot”) includes at least a frame 102, a drive system 104, an electronics system 106, and a cleaning assembly 108. The cleaning robot 100 can be used to clean (e.g., vacuum, scrub, disinfect, etc.) any suitable surface area such as, for example, a floor of a home, commercial building, warehouse, etc. The robot 100 can be any suitable shape, size, or configuration and can include one or more systems, mechanisms, assemblies, or subassemblies that can perform any suitable function associated with, for example, traveling along a surface, mapping a surface, cleaning a surface, and/or the like.

The frame 102 of cleaning device 100 can be any suitable shape, size, and/or configuration. For example, in some embodiments, the frame 102 can include a set of components or the like, which are coupled to form a support structure configured to support the drive system 104, the cleaning assembly 108, and the electronic system 106. Cleaning assembly 108 may be connected directly to frame 102 or an alternate suitable support structure or sub-frame (not shown). The frame 102 of cleaning device 100 further comprises strobe light 110, front lights 112, a front sensing module 114 and a rear sensing module 128, rear wheels 116, rear skirt 118, handle 120 and cleaning hose 122. The frame 102 also includes one or more internal storage tanks or storing volumes for storing water, disinfecting solutions (i.e., bleach, soap, cleaning liquid, etc.), debris (dirt), and dirty water. More information on the cleaning device 100 is further disclosed in U.S. utility patent application Ser. No. 17/650678, entitled “APPARATUS AND METHODS FOR SEMI-AUTONOMOUS CLEANING OF SURFACES” filed on Feb. 11, 2022, the disclosure which is incorporated herein by reference in its entirety.

More particularly, in this embodiment, the front sensing module 114 further includes structured light sensors in a vertical and horizontal mounting position, an active stereo sensor and a RGB camera. The rear sensing module 128, as seen in FIG. 3, consists of a rear optical camera. In further embodiments, front and rear sensing modules 114 and 128 may also include other sensors including one or more optical cameras, thermal cameras, LiDAR (Light Detection and Ranging), structured light sensors, active stereo sensors (for 3D) and RGB cameras.

The back view of a semi-autonomous cleaning device 100, as seen in FIG. 3, further shows frame 102, cleaning hose 122, clean water tank 130, clean water fill port 132, rear skirt 118, strobe light 110 and electronic system 106. Electronic system 106 further comprises display 134 which can be either a static display or touchscreen display. Rear skirt 118 consists of a squeegee head or rubber blade that engages the floor surface along which the cleaning device 100 travels and channels debris towards the cleaning assembly 108.

FIG. 3 further includes emergency stop button 124 which consists of a big red button, a device power switch button 126 and a rear sensing module 128. Rear sensing module 128 further comprises an optical camera that is positioned to sense the rear of device 100. This complements with the front sensing module 114 which provides view and direction of the front of device 100, which work together to sense obstacles and obstructions.

### System1

One method of addressing the precise and continuous tracking of a robot's pose in dynamic environments (Problem 1) is to use continuous localization algorithms. A hybrid mapping and localization system (herein referred to System1) is disclosed.

According to System1, when the localization quality is sufficiently high, based on a validated points localization monitor metric, then map updates are allowed to be made on the localization map. This helps localizing in dynamic environments because these environment changes are integrated into the underlying map, so that the particle filter does not snap to incorrect object locations.

According to the disclosure, System1 is a system for simultaneous localization and mapping (SLAM) on a pre-created map and by usage of laser scans from one or two 2D LiDAR sensors. System1 consists of three main components:
Probabilistic Occupancy Grid
2D Laser Scan Matcher (inherited from Hector SLAM)
Particle Filter (PF)

According to the disclosure, the main idea of the system is updating of the pre-created map by new observations of the environment and localization on this map with two consequent localization methods. The probabilistic map provides an occupancy map that has tolerance to sensor noise and non-static objects.

Particle Filter (PF) is a part of localization that is responsible for the robustness of localization, whereas Scan matching ensures better accuracy. Both provide a robust and accurate fitting of every laser scan to the current map. The map is updated only if localization obtained from Particle Filter with Scan Matcher has enough level of confidence. The confidence, in turn, is based on a calculation of covariance of the current pose and the fitting score of the last scan to the map.

According to the disclosure, the SLAM does not have explicit loop closure methods, however, the scan matching from scan to map and the particle filter that tracks the motion on the updated map provides the same abilities inherent in SLAM systems with loop closure mechanism.

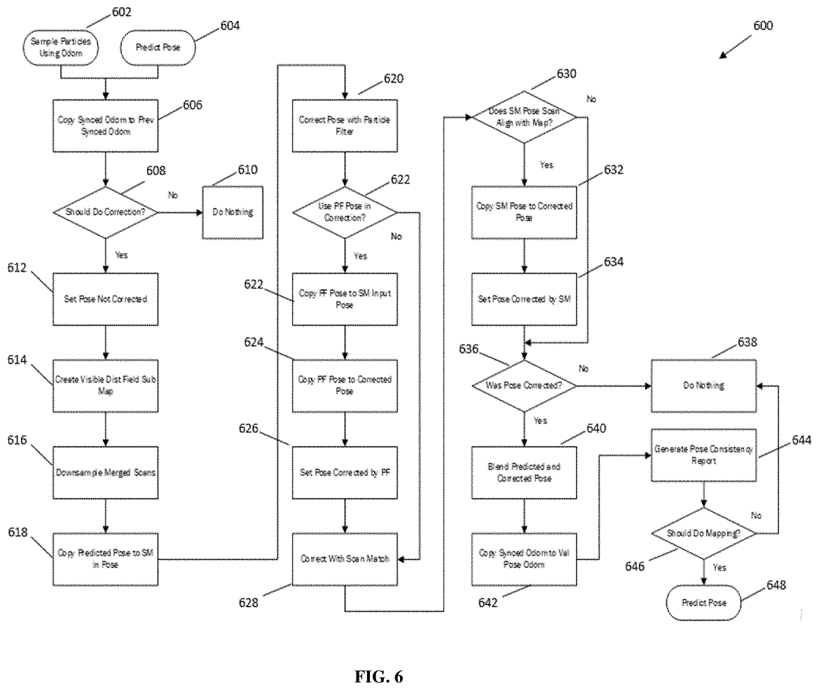

FIG. 6 is a diagram illustrating an exemplary workflow of System1. According to FIG. 6, System1 600 initiates with step 602 with sample particles using odometry (or odom for short) and predict pose at step 604 simultaneously. Next, the step of 606 consisting of copy synched odom to previous synced odom is executed. System1 600 then determines whether to do correction at step 606.

According to FIG. 6, if no correction is required at step 608, then do nothing at step 610. However, if correction is required at step 608, the next step is to set the pose to not corrected (or uncorrected) at step 610. Thereafter, the step is to create the visible distribution field submap at step 614. The next step is to downsample the merges scans at step 616 and then copy the predicted pose to scan matching (SM) in pose at step 618.

According to FIG. 6, System1 600 then corrects pose with particle filter (PF) at step 620. The next step is then to determine whether to use the particle filter (PF) pose in correction at step 622. If not, the process moves to the step to correct the pose with scan matching (SM) at step 628. If the pose data is used in correction at step 62, the system then copies the particle filter (PF) to the scan matching (SM) input pose at step 622.

According to FIG. 6, the next step is to copy the particle filter (PF) pose to the corrected pose at step 624. Thereafter, the step of setting pose corrected by the particle filter (PF) at step 626. Sysem1 600 then moves to correct with scan match (SM) at step 628.

According to FIG. 6, system 600 then determines whether the scan matching (SM) pose scan is aligned with the map at step 630. If yes, the step of copy scan match pose to corrected pose is executed at step 632. Thereafter, the system sets pose corrected by scan match at step 634. If no alignment at step 630, the system jumps to step 634 directly.

According to FIG. 6, system 600 then determines whether the pose was corrected at step 636. If no, do nothing at step 638. If yes, system 600 then blends predicted and corrected pose at step 640. Thereafter, system 600 copies the synched odom to val pose odom at step 642. Next a pose consistency report is generated at step 644.

Finally, the system 600 then determines whether to do mapping at step 646. If no, do nothing at step 638. If yes, the process concludes by predicting the pose at step 648.

According to the disclosure, the main components of System1 include:
Initial, robust estimation. Using the previous localization estimate as the initial guess, an initial guess of the new localization estimate is produced that does not necessarily need to be accurate (i.e., less accurate than the desired +/−5 cm error) but should be robust to multiple possible local minima. Put differently, if the environment contains symmetries or other ambiguities, this initial robust estimation is tolerant and provides a reasonable estimate that is refined in the secondary, more accurate estimation step.

Secondary, accurate estimation. Using the initial robust guess from the initial estimation, the estimate is refined using a local-minimum-seeking approach. System1 uses a Hessian scan matcher in this role, minimizing the distance between points in the laser scan and obstacles in the map.

Map update. The original map is updated probabilistically using the latest laser scan. This approach maps both obstacles and free space and is robust against dynamic obstacles. The updated map is used in both the initial and secondary estimation steps.

### System2

According to the disclosure, a further hybrid mapping and localization system using continuous localization algorithms that is much closer to true simultaneous localization and mapping (SLAM) system is disclosed (herein referred to as System2). According to the disclosure, System2 builds a map effectively from scratch.

The SLAM problem is widely discussed in the literature and looks at ways to most consistently associate the entire history of odometry and lidar observations to minimize some notion of information misalignment (in a sense, information entropy). System2 is unique in its implementation because it contains an alignment workflow, which estimates the transformation between the map being generated by SLAM (in the SLAM workflow) with an a priori original map. This step of alignment between the SLAM map and original map is a unique and required step. This is because the robot must respect the cleaning plan, which is a highly annotated map containing input from the customer, including areas that the robot must avoid, slow down, should or should not be cleaned, etc. Put differently, the robot must know where these special annotations are located with respect to the robot. As a result, it cannot simply perform SLAM but also localize as well within the cleaning plan.

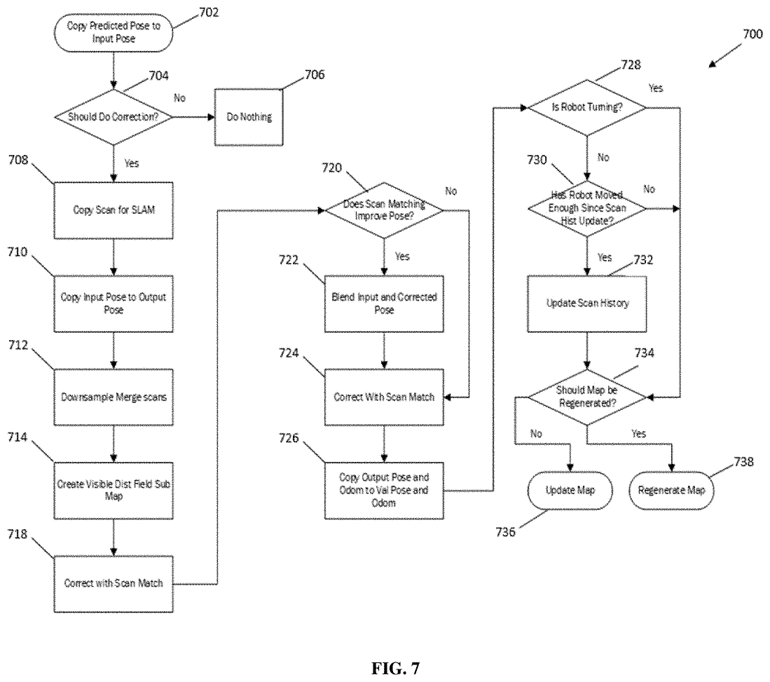

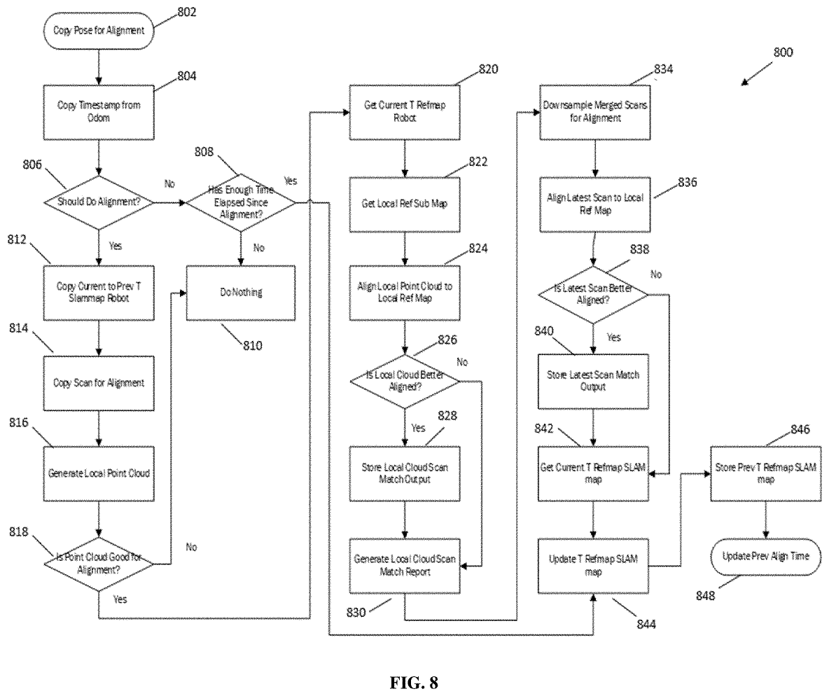

The two main workflows in System are described as follows:
The SLAM workflow (FIG. 7). This workflow is a modification of a typical SLAM algorithm. It is in a sense a “sliding window” SLAM, in that a map is built around and moves with the robot. A Hessian scan matching algorithm corrects the pose of the robot against this map.
The alignment workflow (FIG. 8). This workflow aligns the sliding window SLAM map with the original map that contains the annotations provided by the customer. More specifically, a validated section of the sliding window SLAM map is aligned with a submap of the original map. This is an iterative process that first uses a rough alignment with the sliding window map and is then refined with the latest laser scan. This gives preference in alignment to the points nearest to the robot.

FIG. 7 is a diagram illustrating the SLAM workflow. According to FIG. 7 the SLAM workflow 700 initiates with step 702 to copy predicted pose to input pose. Next, workflow 700 then determines whether to do correction at step 704.

According to FIG. 7, if correction is not required (i.e., no), then do nothing at step 706. However, if correction is required (i.e., yes) the next step is to copy scan for SLAM at step 708. Thereafter, the next step is copy input pose to output pose at step 710. The next step is to downsample merge scans at step 712. Thereafter, the next step is to create a visible distribution field submap at step 714 followed by the step of correcting with scan match (SM).

According to FIG. 7, workflow 700 then determines whether scan matching (SM) improves pose at step 720. If yes, then the step of blending input and corrected pose is executed at step 722. Thereafter, workflow 700 moves to correct with scan match (SM) at step 724. If no at step 720, workflow 700 moves directly to step 724 to correct with scan match.

According to FIG. 7, workflow 700 then copies output pose and odom to val pose and odom at step 726. Thereafter, workflow 700 then determines whether the robot is turning at step 728. If no, workflow 700 then determines whether the robot has moved enough since the last scan history update. If yes, then update scan history at step 732. Thereafter, workflow 700 then determines whether the map should be regenerated at step 734.

According to FIG. 7, if robot is turning at step 728, workflow 700 jumps to step 734 to determine map regeneration. Furthermore, if no at step 730, workflow 700 also jumps to step 734 accordingly.

According to FIG. 7, if map is not regenerated (i.e., No) at step 734, workflow 700 updates the map at step 736. However, if map is to be regenerated (i.e., Yes) at step 734, workflow 700 then regenerates the map at step 738.

FIG. 8 is a diagram illustrating the alignment workflow. According to FIG. 8, alignment workflow 800 initiates with the step of copying pose for alignment at step 802. Next, workflow 800 copies timestamp from odom at step 804.

According to FIG. 8, workflow 800 then determines whether to do alignment at step 806. If no, the step of whether enough time has elapsed since last alignment is executed at step 808. If no at step 808, then do nothing at step 810.

According to FIG. 8, if alignment is to be done (i.e., Yes) at step 806, workflow 800 then copies current to previous T SLAM map robot at step 812. Thereafter, the step of copying scan for alignment is executed at step 814. The next step is to generate a local point cloud at step 816.

According to FIG. 8, workflow 800 then determines whether the point cloud is good for alignment at step 818. If no, then do nothing at step 810. If yes, workflow 800 then retrieves the current T refmap from robot at step 810. Thereafter, workflow 800 retrieves the local ref submap at step 822. The next step is to align the local point cloud to local reference map at step 824.

According to FIG. 8, workflow 800 then determines whether local point cloud is better aligned at step 826. If yes, workflow 800 stores the local cloud scan to match output at step 828. The next step is to generate local cloud scan to match report at step 830. If the response at step 826 is no (i.e., not better aligned), the process jumps to step 830 directly.

According to FIG. 8, workflow 800 then downsamples the merged scans for alignment at step 834. The next step is to align the latest scan to the local reference map at step 836.

According to FIG. 8, workflow 800 then determines whether the latest scan is better aligned at step 838. If yes, the step of storing latest scan match (SM) output is executed at step 840. Thereafter, workflow 800 then retrieves current T reference map SLAM map at step 842. The next step is to update T reference map SLAM map at step 844.

According to FIG. 8, if the latest scan is not better aligned (i.e., No) at step 838, the workflow jumps to step 842 directly. Furthermore, if enough time has elapsed since last alignment (i.e., Yes) at step 808, workflow 800 jumps to the step of updating T reference map SLAM map at step 844.

According to FIG. 8, the final steps include storing the previous T reference map SLAM map at step 846 and updating the previous alignment time at step 848.

### Localization Monitor

Coupled with the continuous localization algorithm is also the localization monitor, which rapidly consumes reports published by the localization system and compares values in these reports with thresholds. The reports contain numerous metrics that can be used to evaluate the health and accuracy of the localization system.

The report addresses the following issues:
How well the current scan aligns with the obstacles in the original map.
The number of obstacles that were previously observed in the map and should now be observable but are missing.
The size of the localization corrections currently being applied by the localization system.
The uncertainty in the scan matching process.
The distance the robot has driven since a localization correction was successfully applied.

When different combinations of thresholds are violated over a sustained period, the localization monitor triggers that the robot is considered lost, which will immediately stop the robot. At this point, remote monitoring intervention is performed to either correct the position of the robot or verify that a false positive has occurred.

An example of a localization monitor is disclosed in PCT publication WO2019183727A1 filed on Mar. 27, 2018, entitled “Safety systems for semi-autonomous devices and methods of using the same” which is incorporated by reference in its entirety.

### Addressing Problem 2

According to the disclosure. a workflow-like framework to allow reusable components of various localization algorithms to be mixed and matched to streamline the creation and the evaluation of existing and new algorithms is disclosed.

At its highest level, the localization and mapping framework is designed to encourage code reuse by organizing algorithms into small single-purpose entities called tasks that can then be configured and assembled into workflows. These workflows are started and stopped by a driver, which is controlled via a communication interface such as ROS.

The algorithms called by the tasks are organized according to their core functionality, such as pose estimation, pose validation, and mapping. In addition to these algorithms, specifications are provided for the base data types (e.g., pose, map), the execution framework (e.g., task, workflow), the runtime (i.e., use of the execution framework for localization and mapping), the localization monitor, and the communication interface.

According to the disclosure, the SLAM system consists of a probabilistic occupancy grid, a 2D laser scan matcher, a particle filter, and a plurality of adapters. The adapters include an odometry adapter, a laser scan adapter, a pose adapter, and a map adapter. The odometry adapter receives odometry data from the semi-autonomous device. The laser scan adapter is configured to receive laser scan and outputs point cloud created from input scans after pre-filtering. The pose adapter receives initial position and provides localization results. The map adapter is configured to receive the original cleaning map plan and generate internal maps.

According to further embodiments of the disclosure, the SLAM system further comprises additional components including the following:
Map reference frame
Robot reference frame
Odom reference frame
Sensor reference frame
Execution framework
Base types
Pose estimation algorithms
Pose validation algorithms
Mapping algorithms
Shared Algorithms
Runtime
Monitor
ROS/Communication Interface

### Map Reference Frames

The map reference frame is the inertial reference frame relative in which localization is performed. That is, the pose of the robot is reported as the position and heading of the coordinate axes of the robot reference frame reported in the map reference frame. Note that the heading is defined as the counterclockwise angle from the x-axis of the map reference frame to the x-axis of the robot reference frame. The map reference frame uses the coordinate system as described in the grid map library [https://github.com/ANYbotics/grid_map].

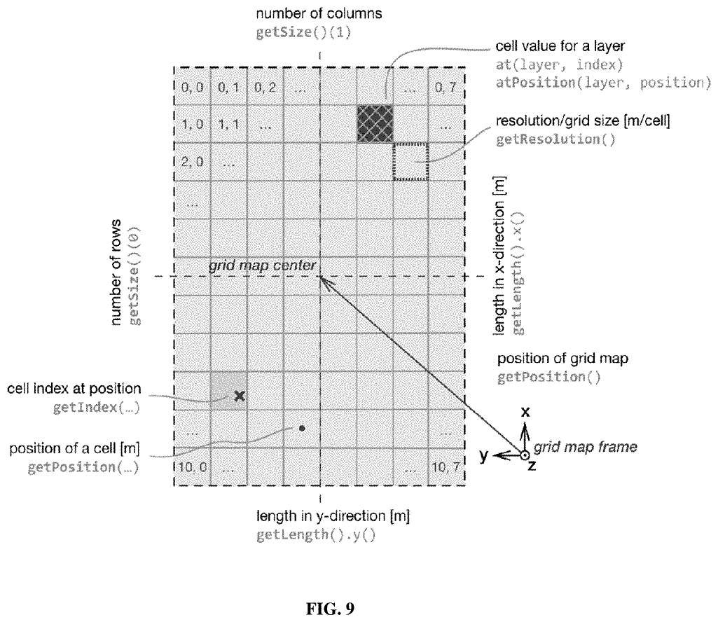

FIG. 9 is a diagram illustrating an exemplary reference map illustrating the conventions of the grid map. According to FIG. 9, the grid map centre and origin of the grid map reference frame coincide with each other. Put differently, the position of the grid map as described in the figure is (0, 0). Note that the indices of the cells always start at the “top left” of the map.

### Robot Reference Frame

The robot reference frame is a moving reference frame attached to the robot, located at the front wheel. The x-axis of the coordinate axes points forward and the y-axis points left. The transform from the robot reference frame to the map reference frame represents the current best estimate of the pose of the robot in the map.

### Odom Reference Frame

The odom reference frame is a fixed frame relative to the robot reference frame. It represents the smoothly-changing pose of the robot as reported by odometry. At start-up, the odom and map reference frame are identical. As dead-reckoning errors accumulate, the transform between them grows. The primary use of the odom reference frame is using sequential estimates of the pose to predict short-term changes in pose. Another use is comparing how the poses reported by odometry evolve over time to determine the likelihood that the wheels of the robot are slipping.

### Sensor Reference Frame

The sensor reference frame is attached to an exteroceptive (i.e., environment-measuring) sensor that is rigidly fixed to the robot. Note that there is more than one sensor reference frame that should be named accordingly (e.g., front Lidar, rear_lidar, etc.). The data types storing the data from these sensors have fields with the data in their original sensor reference frames, as well as the same data transformed to the robot reference frame. The data in the original reference frame is kept because it sometimes provides additional information that is lost when transformed (e.g., regular spacing of data, well defined field of view).

### Execution Framework

The execution framework is a hierarchy of elements: the data manager (stores all data such as poses, maps, and sensor data), task functions (algorithms such as scan matching), tasks (runs task functions using data from the data manager), workflows (ordering of tasks to form more complex behaviour such as continuous localization), and the driver (interface to start and stop workflows). Importantly, the execution framework is completely independent of localization and mapping. That is, it provides the elements listed above in a generic way that is agnostic to how it is used (i.e., what the tasks contain, how the workflows are organized, what actions the driver can take, etc.).

### Base Types Algorithms

Localization and mapping have a set of base types that are used by all types of algorithms (e.g., from pose estimation, mapping, pose validation). These base types include the top-level types that are directly used in task functions (e.g., pose, map, global pose report) as well as types from which those top-level types are composed. For example, the global pose report contains a scan match score report, which contains scan match score stats.

### Pose Estimation Algorithms

Pose estimation is performed by a collection of task functions and regular functions that estimate the pose using data from a sensor or knowledge about the motion of the robot. For example, scan matching and particle filtering are examples of pose estimation algorithms.

### Pose Validation Algorithms

Pose validation is performed by a collection of task functions and regular functions that implement pose validation algorithms. A function is considered to implement a pose validation algorithm if it calculates validation data about a pose (e.g., how well a scan taken at a pose matches a map), determines the validity of a pose based on validation data, or calculates data about the environment whose purpose is to help validate poses (e.g., determining landmarks in a map that should be observed by valid poses).

### Mapping Algorithms

Mapping is performed by a collection of task functions and regular functions that create or modify maps using sensor data. For example, updating the occupancy of a map using a laser scan is an example of a mapping algorithm.

### Shared Algorithms

There exist some algorithms that do not fit under the definition of a more specific collection of algorithms (e.g., pose estimation, mapping) and/or provide functionality that may be useful to more than one category.

### Runtime

The localization and mapping runtime specifies how the execution framework is used for localization and mapping. More specifically, it outlines the data that will be in the data manager, the tasks and workflows that are needed, and a driver that executes the workflows using actions. The execution framework describes what each of these elements are (task function, data manager, tasks, workflows, driver), while the runtime provides details how they can be leveraged into a full localization and mapping system.

### Monitor

The monitor is responsible for determining whether the quality of the pose estimated by the localization and mapping system is acceptable for use by other systems. It consumes reports generated by the localization and mapping system and applies a set of thresholds to the values in those reports (e.g., the maximum allowable number of unoccluded validated points missed by a scan) to determine localization status. This status summarizes the current confidence that localization is being performed sufficiently well.

### ROS or Equivalent Communication Interface

The localization and mapping system can leverage a ROS or similar interface to communicate with other systems on the robot. This consists of the custom message types provided by localization and mapping as well as the topics of which the system subscribes as well as those to which it publishes.

According to embodiments of the disclosure, a hybrid mapping and localization system using a continuous localization framework for dynamic environments for an autonomous indoor semi-autonomous device is disclosed. The system comprises a processor, memory, a probabilistic occupancy grid configured to display maps, a 2D laser scan matcher, a particle filter and a plurality of adapters configured to manage input and output activities for the semi-autonomous.

According to the disclosure, the probabilistic occupancy grid of the system further comprises a global map and local map. The plurality of adapters of the system is selected from a list consisting of an odometry adapter, a laser scan adapter, a pose adapter, and a map adapter.

According to the disclosure, the odometry adapter of the system receives odometry data from the semi-autonomous device. The laser scan adapter of the system is configured to receive laser scan and outputs point cloud created from input scans after pre-filtering. The pose adapter of the system receives initial position and provides localization results. The map adapter of the system is configured to receive the original cleaning map plan and generate internal maps.

According to the disclosure, the system further comprises additional components selected from a list consisting of a map reference frame, a robot reference frame, an odom reference frame, a sensor reference frame, an execution framework, base types, pose estimation algorithms, pose validation algorithms, mapping algorithms, shared Algorithms, a runtime module, a monitor module, a real-time operating system interface and a communication interface.

According to further embodiments of the disclosure, a computer-implemented method for hybrid mapping and localization using a localization framework for an autonomous indoor semi-autonomous device is disclosed. The computer-implemented method comprises the steps of predicting a pose with odometry data, sampling particles using the odometry data, copying synched odometry data to previous synched odometry data, determine whether correction is required and if correction is required, setting the pose as uncorrected, creating a visible distribution field submap, downsampling merges scans, copying predicted pose to scan match in pose and correcting pose with particle filter.

According to the disclosure, the computer-implemented method further comprising the steps of copying the particle filter to scan match input pose, copying the particle filter to the corrected pose, setting pose corrected by the particle filter and correcting with scan matching.

According to the disclosure, the method further comprising the steps of determining whether scan match pose align with map, copying the scan pose to the corrected pose and setting pose corrected by the scan match.

According to the disclosure, the method of claim 9 further comprising the steps of confirming that pose is corrected, blending predicted and corrected pose, copying the synched odometry data to the value pose odometry data, generating a pose consistency report and predicting the updated pose.

According to further embodiments of the disclosure, a computer-implemented method generating a map with a SLAM algorithm for an autonomous indoor semi-autonomous device is disclosed. The method comprises the steps of copying predicted pose to input pose, determine whether correction is required, if correction is required, copying scan for SLAM algorithm, copying input pose to output pose, downsampling merge scans, creating visible distribution field submap and correcting with scan matching.

According to the disclosure, the method further comprising the steps of confirming whether scan matching improve pose, blending input and corrected pose, correcting with scan matching and copying output pose and odometry to value pose and odometry.

According to the disclosure, the method further comprises the steps of determining whether semi-autonomous device is turning, determining whether semi-autonomous device has moved enough since last update and updating the scan history.

According to the disclosure, the method further comprising the steps of determining whether map is to be regenerated, if the map is not to be regenerated, updating map and if map is to be regenerated, regenerate map.

According to further embodiments of the disclosure, a computer-implemented method for aligning a map with a SLAM algorithm for an autonomous indoor semi-autonomous device is disclosed. The method comprises the steps of copying pose data for alignment, copying timestamp from odometer, do alignment and copying current to previous SLAM map, copying pose data for alignment, generating local point cloud, determine whether point cloud is good for alignment, retrieving current T reference map, retrieving local reference submap, aligning local point cloud to local reference map, determine whether local cloud is better aligned, storing local cloud scan to match output, generating local cloud scan to match report, downsampling merged scans for alignment, aligning latest scan to local reference map, determine whether latest scan is better aligned, storing latest scan match output, retrieving current T reference SLAM map, updating T reference SLAM map, storing previous T reference SLAM map and updating previous alignment time.

The methods disclosed herein comprise one or more steps or actions for achieving the described method. The method steps and/or actions may be interchanged with one another without departing from the scope of the claims. In other words, unless a specific order of steps or actions is required for proper operation of the method that is being described, the order and/or use of specific steps and/or actions may be modified without departing from the scope of the claims.

As used herein, the term “plurality” denotes two or more. For example, a plurality of components indicates two or more components. The term “determining” encompasses a wide variety of actions and, therefore, “determining” can include calculating, computing, processing, deriving, investigating, looking up (e.g., looking up in a table, a database, or another data structure), ascertaining and the like. Also, “determining” can include receiving (e.g., receiving information), accessing (e.g., accessing data in a memory) and the like. Also, “determining” can include resolving, selecting, choosing, establishing and the like.

The phrase “based on” does not mean “based only on,” unless expressly specified otherwise. In other words, the phrase “based on” describes both “based only on” and “based at least on.”

While the foregoing written description of the system enables one of ordinary skill to make and use what is considered presently to be the best mode thereof, those of ordinary skill will understand and appreciate the existence of variations, combinations, and equivalents of the specific embodiment, method, and examples herein. The system should therefore not be limited by the above-described embodiment, method, and examples, but by all embodiments and methods within the scope and spirit of the system. Thus, the present disclosure is not intended to be limited to the implementations shown herein but is to be accorded the widest scope consistent with the principles and novel features disclosed herein.

What is claimed:

1. A hybrid mapping and localization system using a continuous localization framework for dynamic environments for an autonomous indoor semi-autonomous device comprising:
a processor;
memory;
a probabilistic occupancy grid configured to display maps.
a 2D laser scan matcher;
a particle filter; and
a plurality of adapters configured to manage input and output activities for the semi-autonomous.

2. The system claim 1 wherein the probabilistic occupancy grid further comprises a global map and local map.

3. The system of claim 1 wherein the plurality of adapters is selected from a list consisting of an odometry adapter, a laser scan adapter, a pose adapter and a map adapter.

4. The system of claim 3 wherein the odometry adapter receives odometry data from the semi-autonomous device.

5. The system of claim 3 wherein the laser scan adapter is configured to receive laser scan and outputs point cloud created from input scans after pre-filtering.

6. The system of claim 3 wherein the pose adapter receives initial position and provides localization results.

7. The system of claim 3 wherein the map adapter is configured to receive the original cleaning map plan and generate internal maps.

8. The system of claim 1 further comprising additional components selected from a list consisting of a map reference frame, a robot reference frame, an odom reference frame, a sensor reference frame, an execution framework, base types, pose estimation algorithms, pose validation algorithms, mapping algorithms, shared Algorithms, a runtime module, a monitor module, a real-time operating system interfance and a communication interface.

8. A computer-implemented method for hybrid mapping and localization using a localization framework for an autonomous indoor semi-autonomous device, the method comprising the steps of:
predicting a pose with odometry data;
sampling particles using the odometry data;
copying synched odometry data to previous synched odometry data;
determine whether correction is required;
if correction is required, setting the pose as uncorrected;
creating a visible distribution field submap;
downsampling merges scans;
copying predicted pose to scan match in pose; and
correcting pose with particle filter.

9. The method of claim 1 further comprising the steps of:
copying the particle filter to scan match input pose;
copying the particle filter to the corrected pose;
setting pose corrected by the particle filter; and
correcting with scan matching.

10. The method of claim 9 further comprising the steps of:
determining whether scan match pose align with map;
copying the scan pose to the corrected pose; and
setting pose corrected by the scan match.

11. The method of claim 9 further comprising the steps of:
confirming that pose is corrected;
blending predicted and corrected pose;
copying the synched odometry data to the value pose odometry data;
generating a pose consistency report; and
predicting the updated pose.

12. A computer-implemented method generating a map with a SLAM algorithm for an autonomous indoor semi-autonomous device comprising the steps of:
copying predicted pose to input pose;
determine whether correction is required;
if correction is required, copy scan for SLAM algorithm;
copying input pose to output pose;
downsampling merge scans;
creating visible distribution field submap; and
correcting with scan matching.

13. The method of claim 12 further comprising the steps of:
confirming whether scan matching improve pose;
blending input and corrected pose;
correcting with scan matching; and
copying output pose and odometry to value pose and odometry.

14. The method of claim 13 further comprising the steps of:
determining whether semi-autonomous device is turning;
determining whether semi-autonomous device has moved enough since last update; and
updating scan history.

15. The method of claim 14 further comprising the steps of:
determining whether map is to be regenerated;
if map is not to be regenerated, updating map; and
if map is to be regenerated, regenerate map.
